(19) United States
(12) Patent Application Publication
(10) Pub. No.: US 2025/0150200 A1
(43) Pub. Date: May 8, 2025

(54) COMMUNICATION DEVICE AND COMMUNICATION METHOD

(71) Applicant: Realtek Semiconductor Corp., HsinChu (TW)

(72) Inventors: Hsin-Chih Huang, HsinChu (TW); Chi-Mao Lee, HsinChu (TW); Hsin-Yu Kuo, HsinChu (TW)

(73) Assignee: Realtek Semiconductor Corp., HsinChu (TW)

(21) Appl. No.: 18/931,087

(22) Filed: Oct. 30, 2024

(30) Foreign Application Priority Data
Nov. 3, 2023 (TW) 112142372

(51) Int. Cl. H04L 1/00

(52) U.S. Cl. CPC H04L 1/0045; H04L 1/0061

(57) ABSTRACT

A communication device includes: a receiving circuit, for receiving a data unit from a transmitter; a comparing circuit, coupled to the receiving circuit, for comparing a target station identity (STAID) with a STAID in the data unit, to generate a comparison result; a processing circuit, coupled to the comparing circuit, for performing a cyclic redundancy check (CRC) according to the comparison result and a check code in the data unit, to generate a check result, and for determining a frequency resource according to the check result and an extremely high throughput signal (EHT-SIG) field in the data unit; and a transmitting circuit, coupled to the processing circuit, for transmitting the frequency resource to a demodulation circuit.

### BACKGROUND OF THE INVENTION

### 1. Field of the Invention

The present invention relates to a communication device and a communication method used in a wireless communication system, and more particularly, to a communication device and a communication method for handling data units.

### 2. Description of the Prior Art

In a communication system, a cyclic redundancy check (CRC) is used to check whether a data unit received by a receiver from a transmitter has errors during transmission. According to data in the data unit, the transmitter generates a check code and appends the check code to the end of the data. After receiving the check code, the receiver performs the CRC for the check code to ensure the correctness of the data in the received data unit. However, the receiver needs to spend a lot of time and resources to perform the CRC when multiple data units are transmitted, which increases the complexity of processing the data units. Thus, how to reduce the complexity of processing the data units is an important problem to be solved.

### SUMMARY OF THE INVENTION

The present invention provides a communication device and a communication method to solve the abovementioned problem.

A communication device comprises: a receiving circuit, for receiving a data unit from a transmitter; a comparing circuit, coupled to the receiving circuit, for comparing a target station identity (STAID) with a STAID in the data unit, to generate a comparison result; a processing circuit, coupled to the comparing circuit, for performing a cyclic redundancy check (CRC) according to the comparison result and a check code in the data unit, to generate a check result, and for determining a frequency resource according to the check result and an extremely high throughput signal (EHT-SIG) field in the data unit; and a transmitting circuit, coupled to the processing circuit, for transmitting the frequency resource to a demodulation circuit.

A communication method comprises: receiving a data unit from a transmitter; comparing a target station identity (STAID) with a STAID in the data unit, to generate a comparison result; performing a cyclic redundancy check (CRC) according to the comparison result and a check code in the data unit, to generate a check result; determining a frequency resource according to the check result and an extremely high throughput signal (EHT-SIG) field in the data unit; and transmitting the frequency resource to a demodulation circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a communication system according to an example of the present invention.

FIG. 2 is a schematic diagram of an extremely high throughput multi-user physical protocol data unit (EHT MU PPDU) according to an example of the present invention.

FIG. 3 is a schematic diagram of an extremely high throughput signal (EHT-SIG) field according to an example of the present invention.

FIG. 4 is a schematic diagram of a user field block according to an example of the present invention.

FIG. 5 is a schematic diagram of a communication device according to an example of the present invention.

FIG. 6 is a flowchart of a process according to an example of the present invention.

FIG. 7 is a flowchart of a process according to an example of the present invention.

### DETAILED DESCRIPTION

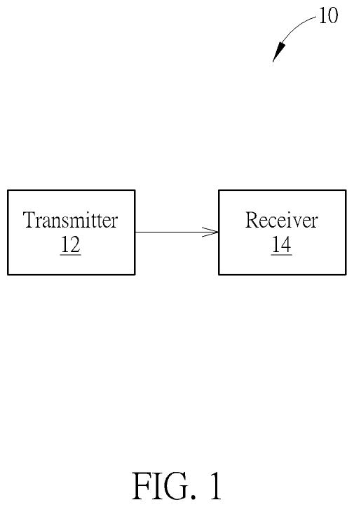

FIG. 1 is a schematic diagram of a communication system 10 according to an example of the present invention. The communication system 10 is briefly composed of a transmitter 12 and a receiver 14. The communication system 10 may be a wireless communication system such as a wireless local area network (WLAN), a Long Term Evolution (LTE) system, a LTE-advanced (LTE-A) system, a 5th generation (5G) system, etc. The transmitter 12 may be an access point (AP) in the WLAN. In addition, the transmitter 12 and the receiver 14 may be realized via a device(s) such as a mobile phone and a laptop, but this is not limited herein. The transmitter 12 and the receiver 14 may support an Institute of Electrical and Electronics Engineers (IEEE) 802.11 standard (e.g., IEEE 802.11AX, 802.11be or a subsequent version). The IEEE 802.11 standard may support an Orthogonal Frequency Division Multiple Access (OFDMA) and/or a Multi-User Multiple-Input Multiple-Output (MU-MIMO), and defines an extremely high throughput multi-user physical protocol data unit (EHT MU PPDU) in order to effectively notify the receiver 14 of transmission information of all scheduled stations (STAs). The EHT MU PPDU may transmit zero data packet format, single user packet format, multi user packet format or OFDMA packet format.

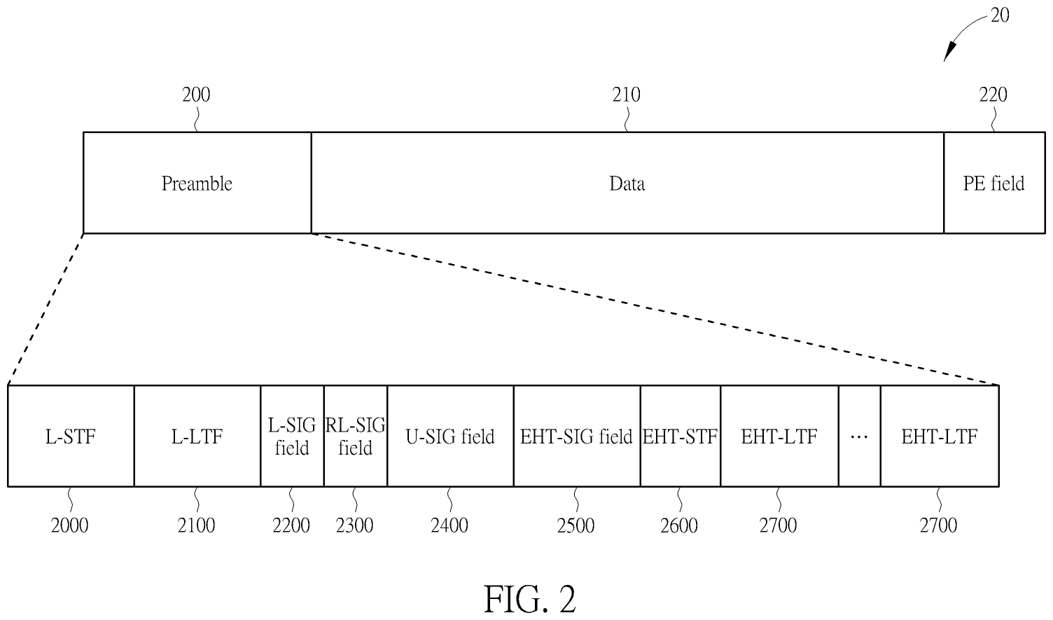

FIG. 2 is a schematic diagram of an EHT MU PPDU 20 according to an example of the present invention. The EHT MU PPDU 20 may be generated by the transmitter 12 in FIG. 1, and be transmitted by the transmitter 12 to the receiver 14. In FIG. 2, the EHT MU PPDU 20 may comprise a preamble 200, data 210 and a Packet Extension (PE) field 220. The data 210 may be used to carry physical layer service data units (PSDU). The PE field 220 may allow the receiver 14 additional time to process the data 210.

In FIG. 2, the preamble 200 may comprise a legacy short training field (L-STF) 2000, a legacy long training field (L-LTF) 2100, a legacy signal (L-SIG) field 2200, a repeated L-SIG (RL-SIG) field 2300, a universal signal (U-SIG) field 2400, an extremely high throughput signal (EHT-SIG) field 2500, a EHT-STF 2600 and a plurality of EHT-LTFs 2700. The L-STF 2000 may be used for packet detection, auto gain control (AGC) and coarse frequency offset estimation. The L-LTF 2100 may be used for fine frequency offset estimation and channel estimation. The L-SIG field 2200 may comprise information such as a transmission rate and length. The RL-SIG field 2300 may be used for auto detection. The U-SIG field 2400 may be used to define characteristics of the data 210, such as communication version, transmission direction (e.g., uplink (UL) or downlink (DL)), and transmission opportunity (TXOP) duration. The EHT-SIG field 2500 may comprise resource unit assignment information. The EHT-STF 2600 may be used to improve automatic gain control estimation in MIMO transmissions. The EHT-LTF 2700 may be used for MIMO channel estimation and pilot subcarrier tracking.

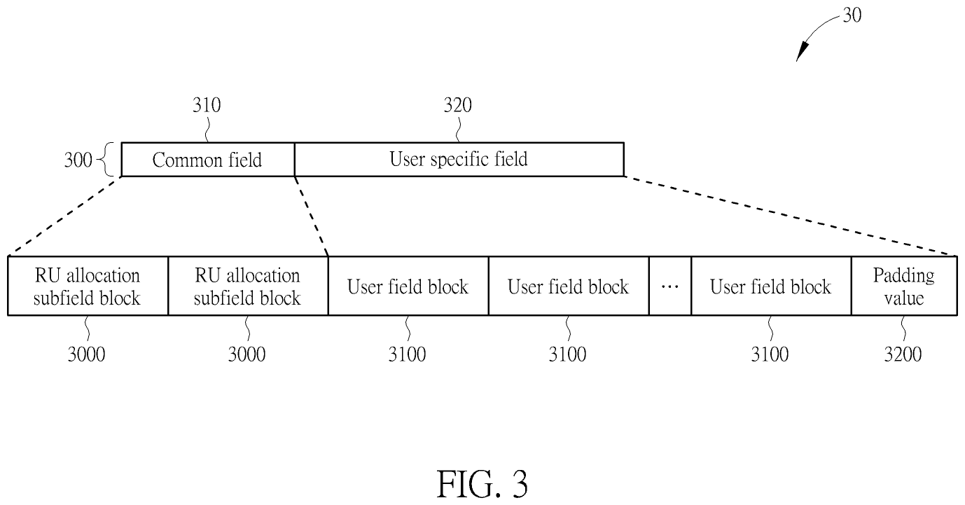

FIG. 3 is a schematic diagram of an EHT-SIG field 30 according to an example of the present invention. The EHT-SIG field 30 may be applied in the EHT-SIG field 2500 in FIG. 2, and may comprise at least one content channel. Each content channel 300 may comprise a common field 310 and a user specific field 320. The common field 310 may comprise a plurality of (e.g., two) resource unit (RU) allocation subfield blocks 3000. The RU allocation subfield block 3000 may comprise at least one RU allocation subfield, a check code and a tail (not shown in FIG. 3). The at least one RU allocation subfield may be used to notify the receiver 14 of the current RU assignment of all data bandwidths (e.g., RU and/or multiple RUs (MRU) in an allocation in a frequency band (e.g., 80 MHZ)). The check code may be used to perform a cyclic redundancy check (CRC). The tail may be used to perform forward error correction (FEC) decoding. The user specific field 320 may comprise a plurality of user field blocks 3100 and a padding value 3200. The user field block 3100 may comprise at least one (e.g., one or two) user field, a check code and a tail (not shown in FIG. 3). The user field may carry transmission information of a STA. Details of the check code and the tail can be known by referring to the above description, and are not narrated herein. The padding value 3200 may be used to pad a length of the user specific field 320 to satisfy a format of the EHT-SIG field 30.

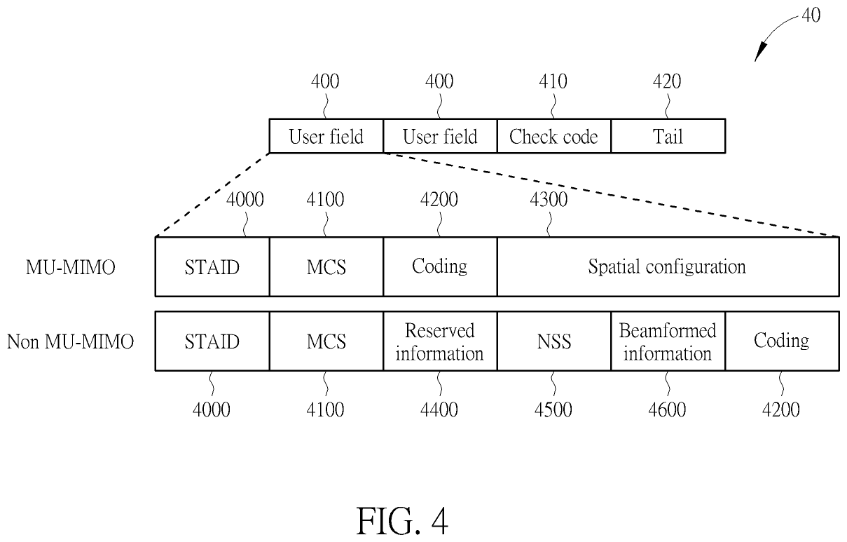

FIG. 4 is a schematic diagram of a user field block 40 according to an example of the present invention. The user field block 40 may be applied in the user field block 3100 in FIG. 3. The user field block 40 may comprise two user fields 400, a check code 410 and a tail 420. In a multi-user MIMO (MU-MIMO) communication system, the user field 400 may comprise a station identity (STAID) 4000, a modulation and coding scheme (MCS) 4100, a coding 4200 and a spatial configuration 4300. In a non MU-MIMO communication system, the user field 400 may comprise a STAID 4000, a MCS 4100, a reserved information 4400, a network status service (NSS) 4500, a beamformed information 4600 and a coding 4200. The STAID 4000 may be used to indicate a destination (e.g., a specific scheduled STA) to which data (e.g., data 210 in FIG. 1) is being transmitted. The MCS 4100 may be used to indicate a modulation scheme and an encoding bit rate. The coding 4200 may be used to indicate a coding rate. The spatial configuration 4300 may be used to configure antenna configurations for the scheduled STA. The reserved information 4400 may be used to configure resources (e.g., time domain resources) for the scheduling STA to receive data units. The NSS 4500 may be used to indicate data transmission rate. The beamformed information 4600 may be used to configure beams for the scheduled STA to receive data units. Details of the check code 410 and the tail 420 can be known by referring to the description of FIG. 3, and are not narrated herein.

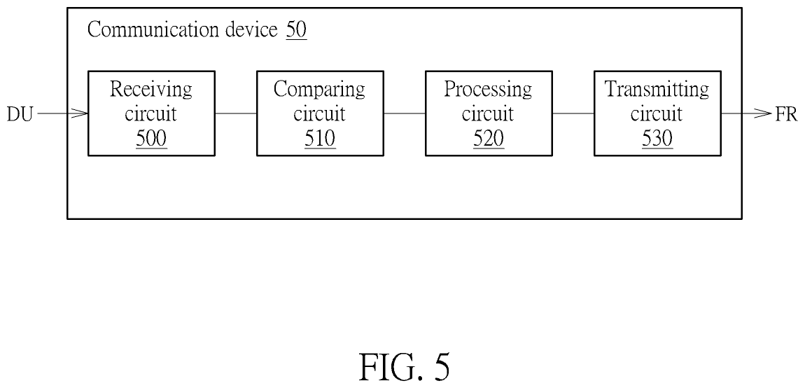

FIG. 5 is a schematic diagram of a communication device 50 according to an example of the present invention. The communication device 50 may be applied in the receiver 14 in FIG. 1, and be used to reduce a complexity of processing data units. The communication device 50 comprises a receiving circuit 500, a comparing circuit 510, a processing circuit 520 and a transmitting circuit 530. In detail, the receiving circuit 500 is configured to receive a data unit DU (e.g., the EHT MU PPDU 20 in FIG. 2) from a transmitter (e.g., the transmitter 12 in FIG. 1). The comparing circuit 510 is coupled to the receiving circuit 500, and is configured to compare a target STAID with a STAID in the data unit DU, to generate a comparison result. The processing circuit 520 is coupled to the comparing circuit 510, and configured to perform a CRC according to the comparison result and a check code in the data unit DU, to generate a check result, and determine a frequency resource FR according to the check result and an EHT-SIG field (e.g., the EHT-SIG field 30 in FIG. 3) in the data unit DU. The transmitting circuit 530 is coupled to the processing circuit 520, and is configured to transmit the frequency resource FR to a demodulation circuit. In one example, the STAID is determined by the communication device 50 (e.g., a medium access control (MAC) layer of the communication device 50). In one example, the frequency resource FR comprises at least one of at least one RU and at least one MRU.

In one example, the communication device 50 further comprises the demodulation circuit. The demodulation circuit is coupled to the transmitting circuit 530, and is configured to demodulate data (e.g., the data 210 in FIG. 2) in the data unit DU according to the frequency resource FR. In one example, the step of the processing circuit 520 performing the CRC according to the comparison result and the check code in the data unit DU comprises: the processing circuit 520 performs the CRC for the check code, when the comparison result indicates that the target STAID and the STAID in the data unit DU are the same. In one example, the processing circuit 520 drops the data unit DU, when the comparison result indicates that the target STAID and the STAID in the data unit DU are different. Then, the receiving circuit 500 receives a next data unit from the transmitter. In one example, the step of the processing circuit 520 determining the frequency resource FR according to the check result and the EHT-SIG field in the data unit DU comprises: the processing circuit 520 analyzes the EHT-SIG field to determine the frequency resource FR, when the check result is successful (e.g., the check code transmitted by the transmitter to the communication device 50 is not distorted). In one example, the processing circuit 520 drops the data unit DU, when the check result fails (e.g., the check code transmitted by the transmitter to the communication device 50 is distorted). Then, the receiving circuit 500 receives a next data unit from the transmitter.

In one example, the data unit DU comprises a preamble, data and a PE field (e.g., the preamble 200, the data 210 and the PE field 220 in FIG. 2). In one example, the preamble comprises the EHT-SIG field (e.g., the EHT-SIG field 2500 in FIG. 2 or the EHT-SIG field 30 in FIG. 3), but is not limited herein. Details of the preamble can be known by referring to the description of FIG. 2, and are not narrated herein. In one example, the EHT-SIG field comprises a common field and a user specific field (e.g., the common field 300 and the user specific field 320 in FIG. 3). In one example, the user specific field comprises a plurality of user field blocks and a padding value (e.g., the user field block 3100 and the padding value 3200 in FIG. 3). In one example, a user field block among the plurality of user field blocks comprises at least one user field and the check code (e.g., the user field 400 and the check code 410 in FIG. 4), but is not limited herein. In one example, a user field among the at least one user field comprises the STAID, but is not limited herein. Details of the user field block and the user field can be known by referring to the description of FIG. 4, and are not narrated herein.

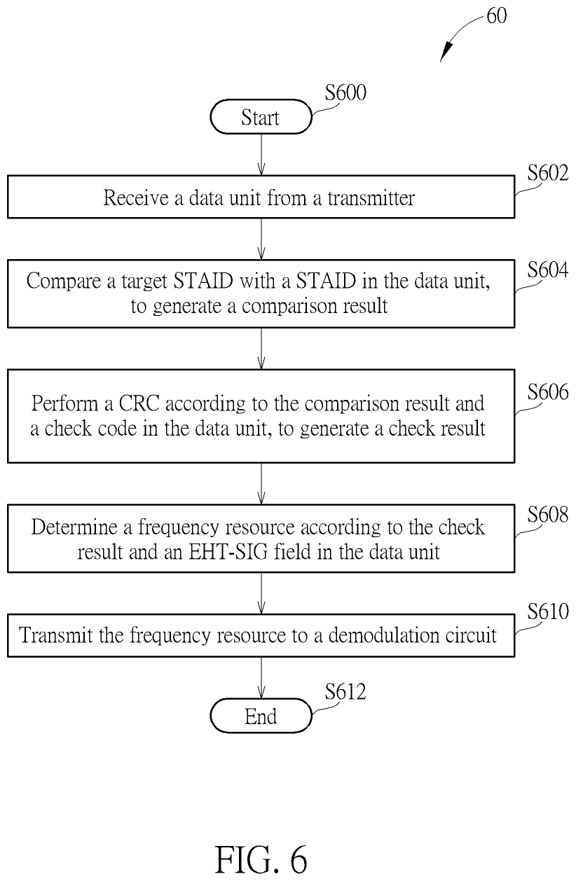

Operations of the communication device 50 in the above examples can be summarized into a process 60 shown in FIG. 6, which reduces a complexity of processing data units. The process 60 includes the following steps:

Step S600: Start.

Step S602: Receive a data unit from a transmitter.

Step S604: Compare a target STAID with a STAID in the data unit, to generate a comparison result.

Step S606: Perform a CRC according to the comparison result and a check code in the data unit, to generate a check result.

Step S608: Determine a frequency resource according to the check result and an EHT-SIG field in the data unit.

Step S610: Transmit the frequency resource to a demodulation circuit.

Step S612: End.

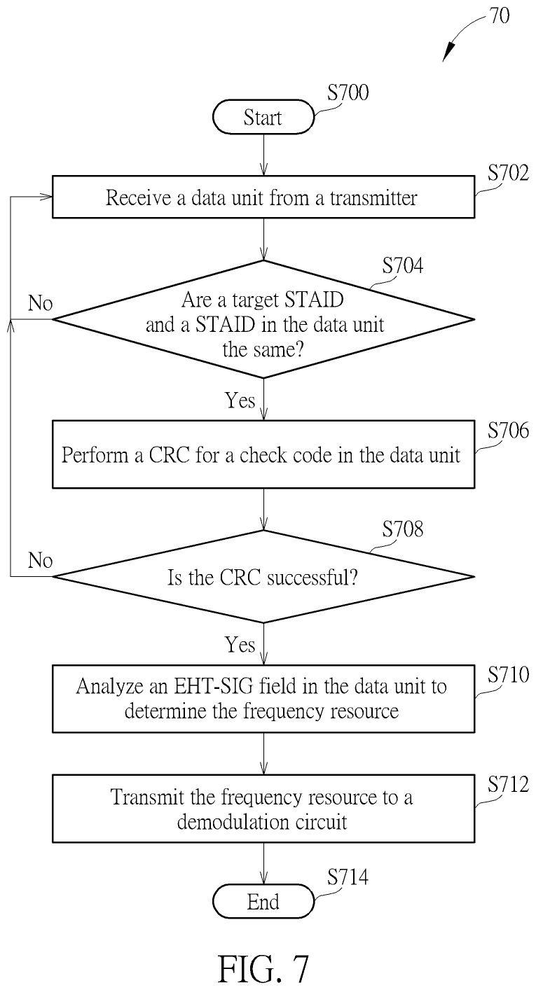

Operations of the communication device 50 in the above examples can be summarized into a process 70 shown in FIG. 7, which reduces a complexity of processing data units. The process 70 includes the following steps:

Step S700: Start.

Step S702: Receive a data unit from a transmitter.

Step S704: Are a target STAID and a STAID in the data unit the same? If yes, perform Step S706. If no, perform Step S702.

Step S706: Perform a CRC for a check code in the data unit.

Step S708: Is the CRC successful? If yes, perform Step S710. If no, perform Step S702.

Step S710: Analyze an EHT-SIG field in the data unit to determine the frequency resource.

Step S712: Transmit the frequency resource to a demodulation circuit.

Step S714: End.

Detailed descriptions and variations of the processes 60-70 can be known by referring to the previous description, and are not narrated herein.

The term “according to” described above may be replaced by the term “via”, “by using” or “in response to”. The term “comprise” described above may be replaced by the term “is”.

It should be noted that the comparing circuit 510 compares the STAID with the STAID in the data unit, which is a post-processing operation method. This operation method may be called “a STAID match” and may be replaced by other post-processing operations, such as a pattern match or a threshold comparison.

It should be noted that there are various possible realizations of the communication device 50 (including the receiving circuit 500, the comparing circuit 510, the processing circuit 520 and the transmitting circuit 530). For example, the circuits mentioned above may be integrated into one or more circuits. In addition, the communication device 50 and the circuits in the communication device 50 may be realized by hardware (e.g., circuits), software, firmware (known as a combination of a hardware device, computer instructions and data that reside as read-only software on the hardware device), an electronic system or a combination of the devices mentioned above, but are not limited herein.

To sum up, the present invention provides a communication device and a communication method. The communication device performs the CRC, if the STAID match is successful (i.e., the target STAID and the STAID in the data unit are the same). In the prior art, the communication device first performs the CRC, wherein if the CRC is successful, the communication device then performs the STAID match. Because a complexity of the STAID match is lower than that of the CRC, compared with the prior art, the complexity of processing data units is reduced. Time and resource for performing the CRC are thereby saved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, comprising:
a receiving circuit, for receiving a data unit from a transmitter;
a comparing circuit, coupled to the receiving circuit, for comparing a target station identity (STAID) with a STAID in the data unit, to generate a comparison result;
a processing circuit, coupled to the comparing circuit, for performing a cyclic redundancy check (CRC) according to the comparison result and a check code in the data unit, to generate a check result, and for determining a frequency resource according to the check result and an extremely high throughput signal (EHT-SIG) field in the data unit; and
a transmitting circuit, coupled to the processing circuit, for transmitting the frequency resource to a demodulation circuit.

2. The communication device of claim 1, further comprising:
the demodulation circuit, coupled to the transmitting circuit, for demodulating data in the data unit according to the frequency resource.

3. The communication device of claim 1, wherein the step of the processing circuit performing the CRC according to the comparison result and the check code in the data unit comprises:
performing the CRC for the check code, when the comparison result indicates that the target STAID and the STAID in the data unit are the same.

4. The communication device of claim 1, wherein the processing circuit drops the data unit, when the comparison result indicates that the target STAID and the STAID in the data unit are different.

5. The communication device of claim 1, wherein the step of the processing circuit determining the frequency resource according to the check result and the EHT-SIG field in the data unit comprises:
analyzing the EHT-SIG field to determine the frequency resource, when the check result is successful.

6. The communication device of claim 1, wherein the processing circuit drops the data unit, when the check result fails.

7. The communication device of claim 1, wherein the data unit comprises a preamble, data and a Packet Extension (PE) field, and the preamble comprises the EHT-SIG field.

8. The communication device of claim 7, wherein the EHT-SIG field comprises a common field and a user specific field, and the user specific field comprises a plurality of user field blocks and a padding value.

9. The communication device of claim 8, wherein a user field block among the plurality of user field blocks comprises at least one user field and the check code, and a user field among the at least one user field comprises the STAID.

10. A communication method, comprising:
receiving a data unit from a transmitter;
comparing a target station identity (STAID) with a STAID in the data unit, to generate a comparison result;
performing a cyclic redundancy check (CRC) according to the comparison result and a check code in the data unit, to generate a check result;
determining a frequency resource according to the check result and an extremely high throughput signal (EHT-SIG) field in the data unit; and
transmitting the frequency resource to a demodulation circuit.

11. The communication method of claim 10, further comprising:
demodulating data in the data unit according to the frequency resource.

12. The communication method of claim 10, wherein the step of performing the CRC according to the comparison result and the check code in the data unit comprises:
performing the CRC for the check code, when the comparison result indicates that the target STAID and the STAID in the data unit are the same.

13. The communication method of claim 10, further comprising:
dropping the data unit, when the comparison result indicates that the target STAID and the STAID in the data unit are different.

14. The communication method of claim 10, wherein the step of determining the frequency resource according to the check result and the EHT-SIG field in the data unit comprises:
analyzing the EHT-SIG field to determine the frequency resource, when the check result is successful.

15. The communication method of claim 10, further comprising:
dropping the data unit, when the check result fails.

16. The communication method of claim 10, wherein the data unit comprises a preamble, data and a Packet Extension (PE) field, and the preamble comprises the EHT-SIG field.

17. The communication method of claim 16, wherein the EHT-SIG field comprises a common field and a user specific field, and the user specific field comprises a plurality of user field blocks and a padding value.

18. The communication method of claim 17, wherein a user field block among the plurality of user field blocks comprises at least one user field and the check code, and a user field among the at least one user field comprises the STAID.
